(19) United States
(12) Patent Application Publication
(10) Pub. No.: US 2024/0160486 A1
(43) Pub. Date: May 16, 2024

(54) COMPUTING RESOURCE MANAGEMENT SYSTEM AND METHOD USING SOFTWARE MODULARIZATION

(71) Applicant: SEMES CO., LTD., Chungcheongnam-do (KR)

(72) Inventors: Sang Hyun SON, Busan (KR); Yeon Chul Song, Seoul (KR); Myeong Jun Lim, Gyeonggi-do (KR); Ji Hoon Yoo, Gyeonggi-do (KR); Kwang Sup Kim, Chungcheongnam-do (KR); Jong Min Lee, Gyeonggi-do (KR); Young Ho Park, Incheon (KR); Jun Ho Oh, Gyeonggi-do (KR); Joong Chol Shin, Gyeonggi-do (KR); Hyun Cheol Cho, Gyeonggi-do (KR)

(21) Appl. No.: 18/380,656

(22) Filed: Oct. 17, 2023

(30) Foreign Application Priority Data
Nov. 16, 2022 (KR) 10-2022-0153802

(51) Int. Cl. G06F 9/50

(52) U.S. Cl. CPC G06F 9/5038; G06F 9/5072; G06F 2209/503; G06F 2209/505

(57) ABSTRACT

A computing resource management system using software modularization in a cluster computing environment in which computing devices are connected, including an application process running on each computing device and an algorithm processing process configured to run independently of the application process and perform task processing on the application process, the computing resource management system including: a task managing system configured to receive a task request message from an application process requiring a task from each computing device; a process managing system configured to confirm an algorithm processing process of computing devices connected to the cluster computing environment, and determine whether there is an algorithm processing process in an idle state to which the application process requested for a task will be assigned; and a performed managing system configured to confirm a result of an application process whose task is performed by the algorithm processing process.

### CROSS-REFERENCE TO RELATED APPLICATION(S)

This application claims benefit of priority to Korean Patent Application No. 10-2022-0153802 filed on Nov. 16, 2022, in the Korean Intellectual Property Office, the disclosure of which is incorporated herein by reference in its entirety.

### BACKGROUND

### 1. Field

The present disclosure relates to a computing resource management system and method using software modularization.

### 2. Description of Related Art

A process performed on each computing device integrates an application process to be processed and an algorithm processing process to be processed, and the process performed on the computing device processes an algorithm using only resources within the same computing device.

In other words, the process only uses resources of the computing device which is running, and when all computing devices are using 100% of their resources, there is no problem; however, when some computing devices are busy, and other computing devices are in an idle state, that is, when not all computing devices are using the entirety of their resources, a resource utilization rate may be lowered, thereby wasting computing resources.

Specifically, high-cost algorithms such as deep learning processing require a large number of computing resources, and one process in the computing device uses a large number of resources when processing each high-cost algorithm. Accordingly, a delay may occur in the processing time of the algorithm assigned consecutively, due to sequential operation performance.

In order to solve this problem, even if numerous computing devices are used, processes performed on each computing device may only use an algorithm processing process of each computing device, and accordingly, computer resources may be wasted as the number of computing devices increases to secure algorithm processing time.

In order to efficiently utilize resources in a cluster environment composed of heterogeneous computing resources, a conventional Patent Document 1 discloses finding a node satisfying the user's resource needs in an available resource pool, and when the node is in use, a process does not wait for the node to be available and tries to find another heterogeneous node.

However, an algorithm processing process is still used to process the process of the computing device within one computing device, and when a plurality of computing devices are connected in a cluster computing environment, an application process within an own computing device cannot be processed by an algorithm processing process within another computing device, and accordingly, high-cost algorithm processing, such as deep learning processing, may not still be solved.

(Patent Document 1) KR 10-2013-0119285 A

### SUMMARY

In order to solve the conventional problem, an aspect of the present disclosure is to provide a computing resource management system and method using software modularization that can allocate application processes of computing devices regardless of computing power, through integrated management of algorithmic processing of computing devices connected to a cluster computing environment.

According to an aspect of the present disclosure, provided is a computing resource management system using software modularization in a cluster computing environment in which computing devices are connected, including an application process running on each computing device and an algorithm processing process configured to run independently of the application process and perform task processing on the application process, wherein the computing resource management system includes: a task managing system configured to receive a task request message from an application process requiring a task from each computing device; a process managing system configured to confirm an algorithm processing process of computing devices connected to the cluster computing environment, and determine whether there is an algorithm processing process in an idle state to which the application process requested for a task will be assigned; and a performed managing system configured to confirm a result of an application process whose task is performed by the algorithm processing process.

According to an aspect of the present disclosure, provided is a computing resource management method using software modularization in a cluster computing environment in which computing devices are connected, including an application process running on each computing device and an algorithm processing process configured to run independently of the application process and perform task processing on the application process, wherein the computing resource management method includes: a task request operation of receiving a task request message of an application process requiring a task from each computing device; a resource assigning operation of confirming an algorithm processing process of computing devices connected to the cluster computing environment, and determining whether there is an algorithm processing process in an idle state to which the application process requested for a task will be assigned; and a task performed operation of confirming a result of an application process whose task is performed.

The present disclosure may provide a computer-readable storage medium having a computer program stored therein, the computer program allowing a computing resource management method through software modularization described above to be performed on a computer.

According to an example embodiment of the present disclosure, each computing device may have an algorithm processing process pool to process an application process independently of computing power thereof, rather than a single algorithm processing process according to computing power, thereby efficiently performing application processing.

Furthermore, when application process processing is delayed because one computing device is in an idle state while the other computing device is busy, resources may be divided maximally and used efficiently without a separate central server.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a view illustrating a cluster computing environment in which computing devices are connected according to an example embodiment of the present disclosure;

FIG. 2 is a view illustrating a software modularization structure for resource sharing of computing devices according to an example embodiment of the present disclosure;

FIG. 3 is a view illustrating idle time generated when an algorithm is processed in a software structure of conventional computing devices;

FIG. 4 is a view illustrating an idle time generated when an algorithm is processed in a software modular structure of computing devices according to an example embodiment of the present disclosure;

FIGS. 5 to 14 are view illustrating an operating process of a computing resource management system through software modularization according to an example embodiment of the present disclosure; and

FIG. 15 illustrates a flowchart of a computing resource management method through software modularization according to an example embodiment of the present disclosure.

### DETAILED DESCRIPTION

Hereinafter, preferred example embodiments will be described in detail with reference to the accompanying drawings. However, in describing preferred example embodiments of the present disclosure in detail, when it is determined that a detailed description of related known functions or configurations may unnecessarily obscure the gist of the present disclosure, the detailed description thereof will be omitted. Furthermore, the same reference numbers are used throughout the drawings to refer to the same or similar portions. Furthermore, in the present specification, it may be understood that the expressions such as “on,” “above,” “upper,” “below”, “beneath,” “lower,” and “side,” merely indicated based on drawings, and may actually vary depending on the direction in which the components are disposed.

Furthermore, throughout the specification, the terms “connected to” or “coupled to” are used to designate a connection or coupling of one element to another element and include both a case where an element is “directly connected or coupled to” another element and a case where an element is “indirectly connected or coupled to” another element via still another element. Furthermore, when a certain portion “includes” or “comprises” a certain component, this indicates that other components are not excluded and may be further included unless otherwise noted.

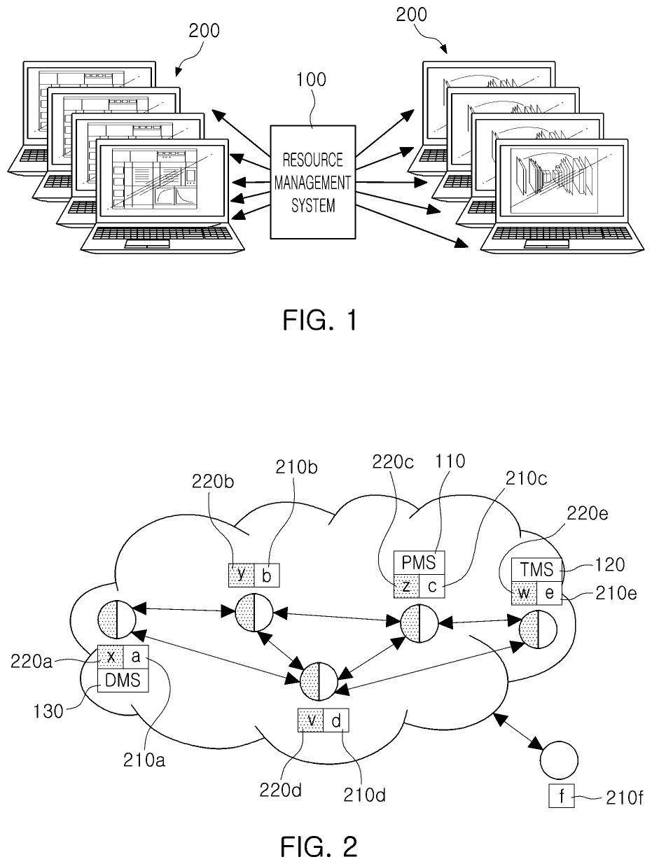

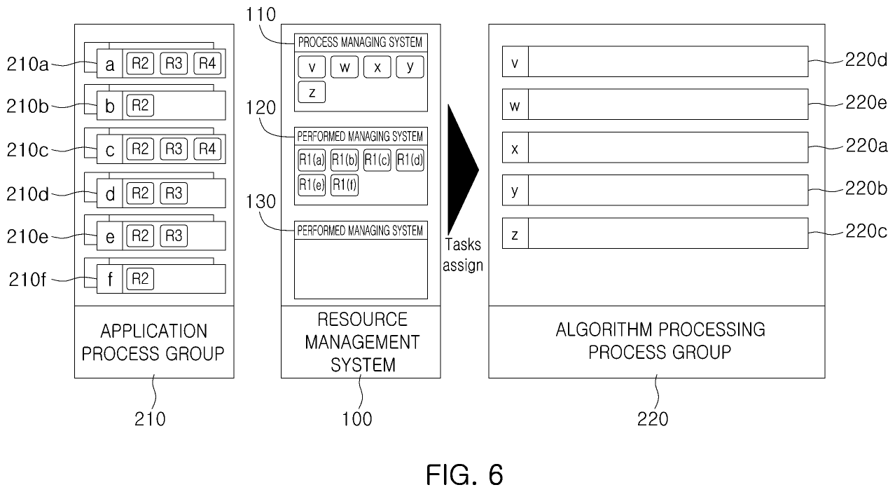

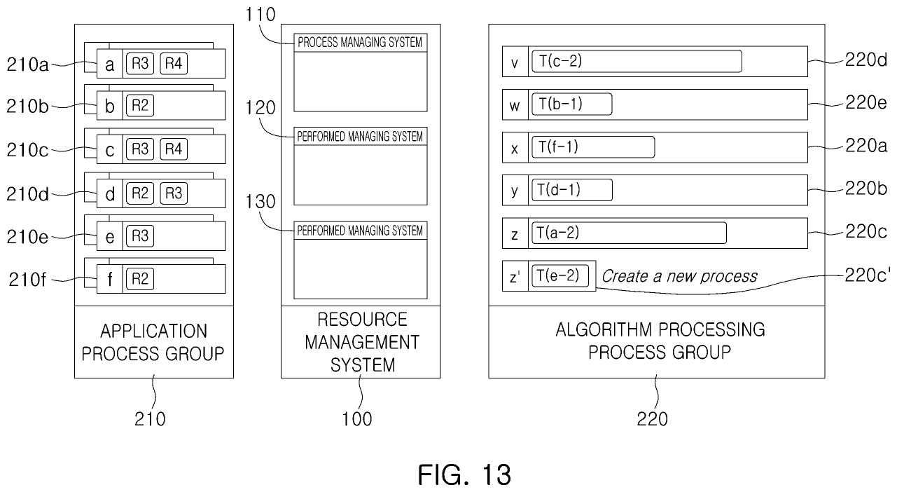

FIG. 1 is a view illustrating a cluster computing environment in which computing devices are connected according to an example embodiment of the present disclosure. Hereinafter, an exemplary diagram for explaining a computing resource management system using software modularization according to an example embodiment of the present disclosure will be described with reference to FIGS. 2 to 14.

Referring to FIG. 1, a number of computing devices 200 are connected to each other, and a resource management system 100 may manage operating processing of the computing devices 200.

The computing resource management system 100 according to an example embodiment of the present disclosure may be at least one computing device 200 in a cluster computing environment in which computing devices 200 including an application process 210 running on each computing device 200 and an algorithm processing process 220 running independently of the application process 210 and performing task processing on the application process 210 are connected.

In other words, the resource management system 100 is not a central server that operates separately, but at least one computing device 200 connected to the cluster computing environment, and may manage a task request, a task performed message, and resource assigning of other computing devices 200 simultaneously with operating the application process 210 for requesting a task and the algorithm processing process 220 for completing a task.

Referring to FIG. 2, the computing resource management system 100 according to an example embodiment of the present disclosure may include a task managing system (TMS) 110 configured to receive a task request message of the application process 210 that requires a task, from each computing device 200, a process managing system (PMS) 120 configured to confirm the algorithm processing process 220 of the computing devices 200 connected in the cluster computing environment and to determine whether there is an algorithm processing process 220 in an idle state to which the application process 210 requested for a task will be assigned, and a performed managing system (DMS) 130 configured to confirm a result of the application process 210 whose task is performed by the algorithm processing process 220.

According to an example embodiment, the task managing system 110, the process managing system 120, and the performed managing system 130 may be performed in at least one computing device 200 connected in the cluster computing environment.

The task managing system 110, the process managing system 120, and the performed managing system 130 may be included in one computing device 200, but may be distributed and disposed to computing devices 200 connected as clients, as illustrated in FIG. 2. According to an example embodiment, a computing device 200 to perform the task managing system 110, the process managing system 120, and the performed managing system 130 may be selected in consideration of computing power or status, and the selected computing device 200 may be changed.

The computing devices 200 connected in the cluster environment may be driven separately into application processes 210a, 210b, 210c, 210d and 210e and algorithm processing processes 220a, 220b, 220c, 220d and 220e. When the task managing system 110 receives a task request message from the application processes 210a, 210b, 210c, 210d and 210e, the process managing system 120 may assign a task request to the algorithm processing processes 220a, 220b, 220c, 220d and 220e.

According to an example embodiment, a computing device including an application process requested for a task, among the application processes 210a, 210b, 210c, 210d and 210e, may be different from a computing device including an algorithm processing process to which the application process 210 requested for a task will be assigned, among the algorithm processing processes 220a, 220b, 220c, 220d and 220e.

For example, if the algorithm processing process 220a belonging to the same computing device 200 is in use when the application process 210a makes a task request, the process managing system 120 may allocate the task request of the application process 210a to an algorithm processing process 220b of another computing device 200 in an idle time.

In another example embodiment, if the algorithm processing process 220a belonging to the same computing device 200 is in an idle state when the application process 210a makes a task request, the task request may be assigned to the algorithm processing process 220a. However, the algorithm processing process 220 responding on a first-come-first-served basis may have been assigned without preferentially considering whether it is the algorithm processing process 220a of the same computing device. Furthermore, according to an example embodiment, the task managing system 110 may receive a task request of an application process 210f that requires a task, from a computing device including only the application process 210f running on a computing device in addition to the computing devices 200 connected in the cluster computing environment.

Referring to FIG. 2, although a computing device 200 is not one of the computing devices 200 connected to each other to form the cluster computing environment, the computing device 200 may transmit the task request of the application process 210f to the task managing system 110 from an external environment of the computing devices 200 connected in the cluster computing environment.

Even if a separate algorithm processing process 220 is not provided due to a lack of computing power, the algorithm processing process 220 of the computing devices 200 may be used by requesting software modularized computing devices 200 according to an example embodiment of the present disclosure to perform algorithm processing. For example, even in computing devices that lack computing power, such as tablets and laptops, and a single logical computer tied to a cluster computer, task efficiency may be improved by allowing a plurality algorithm processing processes 220.

The process managing system 120 according to an example embodiment of the present disclosure may integrate and manage the algorithm processing process 220 of the computing devices 200 connected in the cluster computing environment and may allocate the application process 210 request for a task to the algorithm processing process 220 in an idle state.

Furthermore, according to an example embodiment of the present disclosure, the computing resource management system may further include a database configured to store data necessary to perform algorithm processing of the application process 210 and a remote logic storage (not illustrated) configured to store low-level (RAW) data, such as a network file system (NFS). In this case, the data may include metadata or parameter data.

By deploying the data center for storing and managing the data needed for the task to efficiently process the task, the resource management system 100 according to an example embodiment of the present disclosure may further operate a process of performing a specific function for processing cache data and duplicate data so as to manage data in a data center.

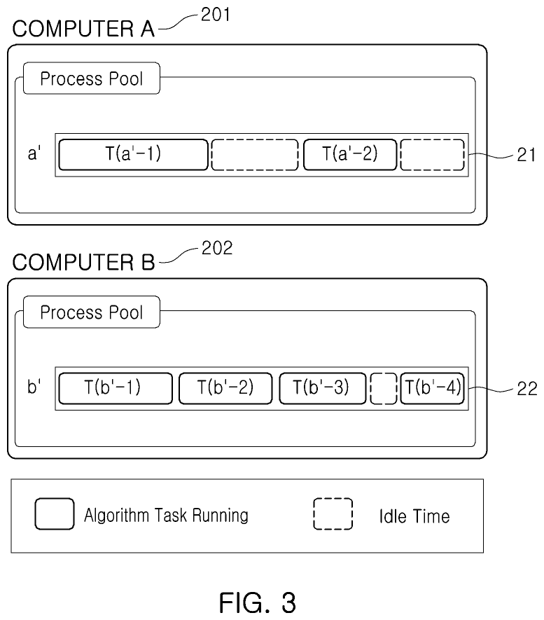

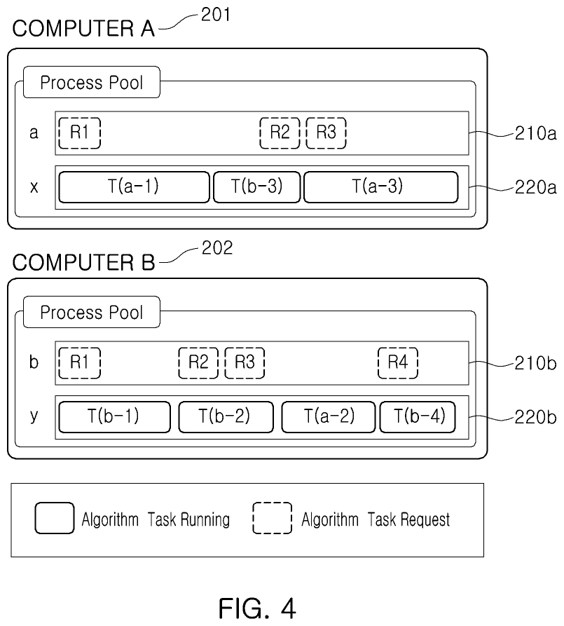

FIGS. 3 and 4 are views illustrating comparison of idle time generated when algorithms are processed in a software structure of computing devices according to the conventional technology and an example embodiment of the present disclosure.

As illustrated in FIG. 3, in the conventional technology, a process a′ (21) performed in a computer A (201) processes tasks T(a′−1) and T(a′−2) using only the resources of the computer A (201), and a process b′ (22) performed in a computer B (202) processes tasks T(b′−1), T(b′−2), T(b′−3) and T(b′−4) using only the resources of the computer B (202). Since the process a′ (21) and the process b′ (22) are not separated into the application process 210 and the algorithm processing process 220, the computer B (202) cannot process the process a′ (21) used in the computer A (201). Accordingly, even if an idle time occurs while the process a′ (21) and the process b′ (22) perform tasks, the computer cannot perform a task of another computer waiting for the idle time. When the task T(a′−3) that requires more resources than the residual Idle Time of the computer A (201) needs to be processed, the task T(a′−3) cannot help waiting sequentially until both tasks T(a′−1) and T(a′−2) are performed.

On the other hand, as illustrated in FIG. 4, according to an example embodiment of the present disclosure, the processes of a computer A (201) and a computer B (202) may be divided into an application process 210 and an algorithm processing process 220. For example, when task request messages such as R1, R2 and R3 are transmitted for an algorithm task request from process a(210a) which is an application process of the computer A (210), the process managing system 120 of the resource management system 100 may allocate the R1, R2 and R3 by integrating a process x (220a), which is an algorithm processing process 220 of the computer A (201), and a process y (220b), which is an algorithm processing process 220 of the computer B (202).

Accordingly, considering the residual resources of the computer A (201) and computer B (202), the task requests may be assigned to the algorithm processing process 220 of the mutual computers to reduce idle time waiting, thereby reducing the actual task processing time.

As illustrated in FIG. 4, the process x(220a) may be set to tasks T(a−1), T(b−3) and T(a−3), and the application processes 210 of the computer A (201) and the computer B (202) may be mixed and assigned.

When the idle time of the computer A (201) is not sufficient to process the task request R2, the task request R2 of the computer A (201) may be assigned to the process y (220b), which is the algorithm processing process 220 of the computer B (202), and the task request R3 of the computer B (202) may be assigned to the process x (220a), which is the algorithm processing process 220 of the computer A (201).

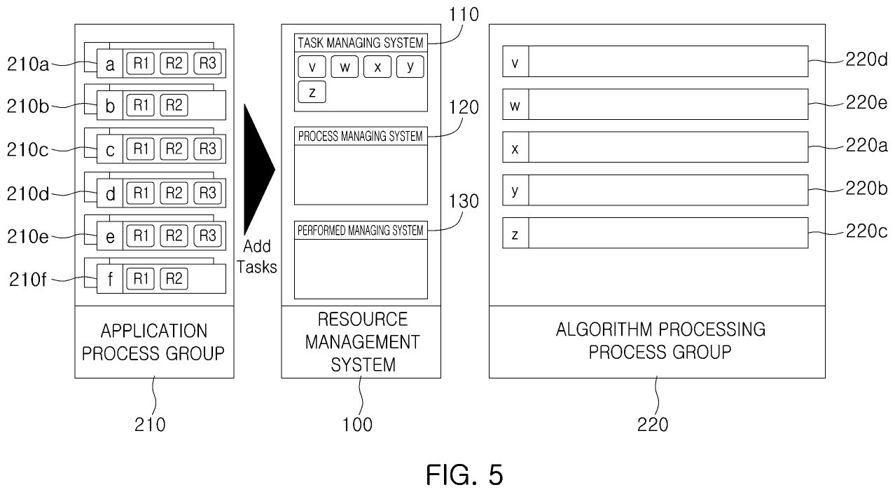

Hereinafter, operations of a specific resource management system 100 will be described with reference to FIGS. 5 to 14.

Application processes 210a, 210b, 210c, 210d, 210e and 210f of computing devices 200 connected in a cluster computing environment or a computing device to request for an algorithm processing task may be managed in an application process group, and algorithm processing processes 220a, 220b, 220c, 220d and 220e of computing devices 200 connected in the cluster computing environment may be managed in an algorithm processing process group.

The application process group and the algorithm processing process group may be managed within each module in each computing device 200 or may be integrated and managed through parameters in at least one computing device 200.

In other words, the application process group and the algorithm processing process group are virtual modules in which each of the application processes 210a, 210b, 210c, 210d, 210e and 210f and each of the algorithm processing processes 220a, 220b, 220c, 220d and 220e are integrated and managed, and actually, the groups are driven within each computing device 200 and are not stored separately.

According to an example embodiment, the process managing system 110 may manage the existence and a task status of each of the algorithm processing processes 220a, 220b, 220c, 220d and 220e so as to confirm the algorithm processing processes 220a, 220b, 220c, 220d and 220e in an idle state.

When task requests (Add Tasks) are received from each of the algorithm processing processes 220a, 220b, 220c, 220d and 220e, the task managing system 110 may register the received task request messages R1(a), R1(b), R1(c), R1(d), R1(e) and R1(f). According to an example embodiment, the received task request messages R1(a), R1(b), R1(c), R1(d), R1(e) and R1(f) may be immediately assigned to the algorithm processing process 220, or the algorithm processing process 220 responding may competitively take the task request messages R1(a), R1(b), R1(c), R1(d), R1(e) and R1(f) to perform the task.

The received task request messages R1(a), R1(b), R1(c), R1(d), R1(e) and R1(f) may be assigned to each of the algorithm processing processes 220a, 220b, 220c, 220d and 220e (Tasks Assign).

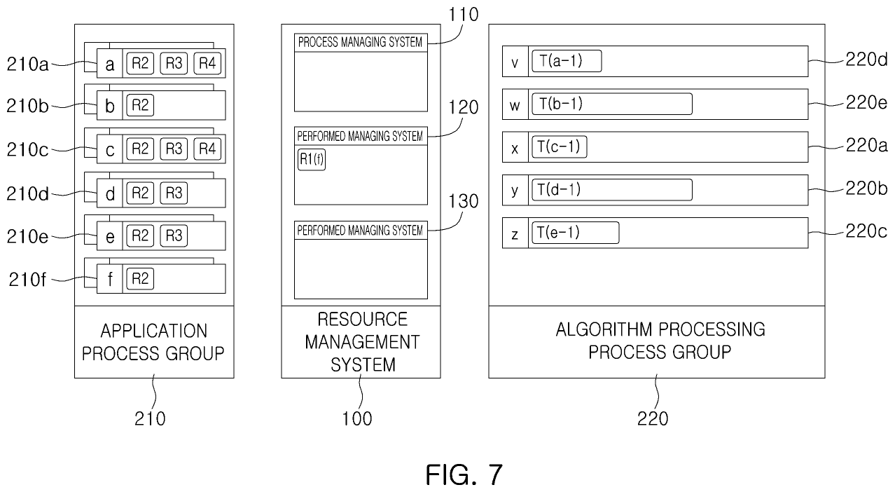

When assigning resources, application processes 210a, 210b, 210c, 210d, 210e and 210f may be assigned to algorithm processing processes 220a, 220b, 220c, 220d and 220e belonging to computing devices 200 different from them. Referring to FIG. 7, the task request message R1(a) of the application process 210a was assigned to the algorithm processing process v (220d), and the task request message R1(b) of the application process 210b was assigned to the algorithm processing process w (220e).

The received task request messages R1(a), R1(b), R1(c), R1 (d) and R1 (e) were assigned to each of the algorithm processing processes 220a, 220b, 220c, 220d and 220e, but since there is no algorithm processing process 220 in an idle state to which the received task request message R1(f)) will be assigned, the received task request message R1(f) may remain in the process managing system 120.

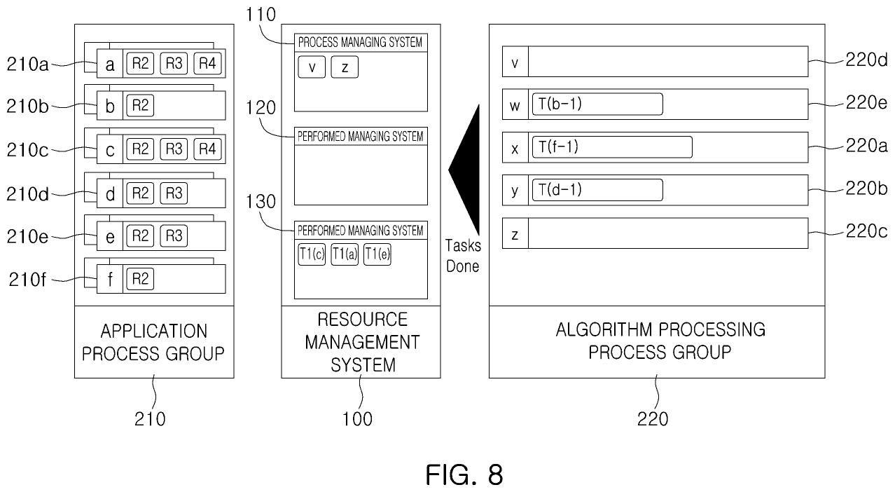

When task T(a−1) of R1(a), task T(c−1) of R1(c) and task T(e−1) of R1(e) having short task time are performed (Tasks Performed) and registered in the order of completion of tasks T1(c), T1(a) and T1(e), the residual task request message R1(f) may be allocated to algorithm processing processes v (220d), x (220a), and z (220c) that have been switched from a busy state to an idle state. Referring to FIG. 8, the residual task request message R1(f) may be allocated to the algorithm processing process x (220a) whose task is performed first. In this case, the algorithm processing processes v (220d) and z (220c) switched to an idle state may inform the process managing system 120 that they are in an idle state and may be registered.

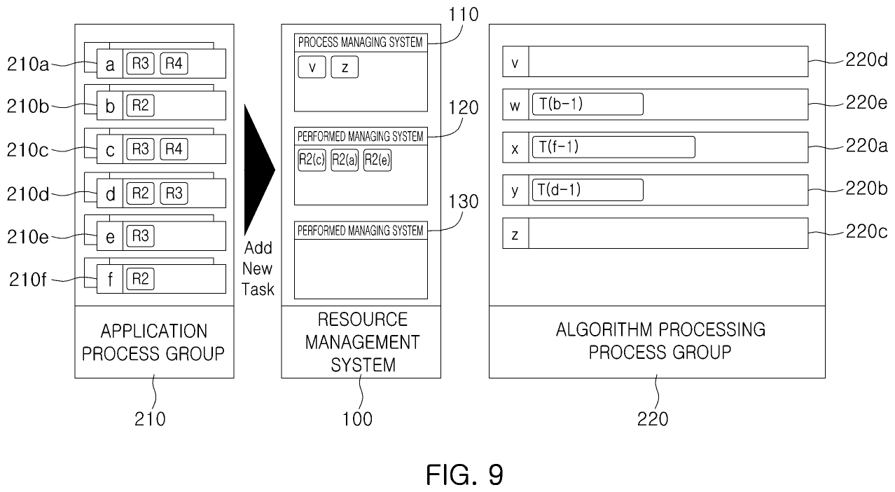

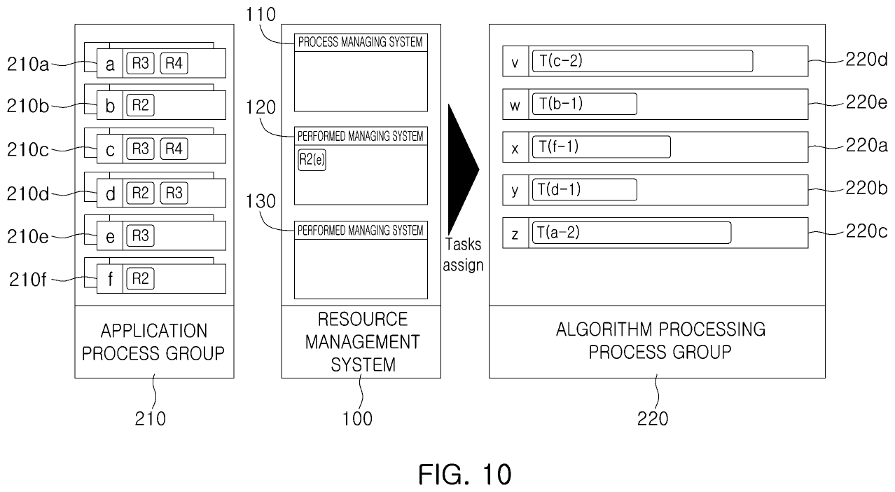

In the above-described operations, the application processes 210 may continuously transmit the task request message to the task managing system 110. Referring to FIGS. 9 and 10, the task request messages R2(c), R2(a) and R2(e) may be further received, and the process managing system 120 may confirm that there are idle algorithm processing processes v (220d) and z (220c) in the idle state, and may assign the task request messages R2(c), R2(a) and R2(e) to the algorithm processing processes v (220d) and z (220c).

In this case, when there is no algorithm processing process 220 in an idle state to which the application process 210 requested for an urgent task will be assigned, the process managing system 120 may request at least one computing device 200 connected in the cluster computing environment to create an additional algorithm processing process in consideration of the residual computing resources of the computing device 200 connected in the cluster computing environment.

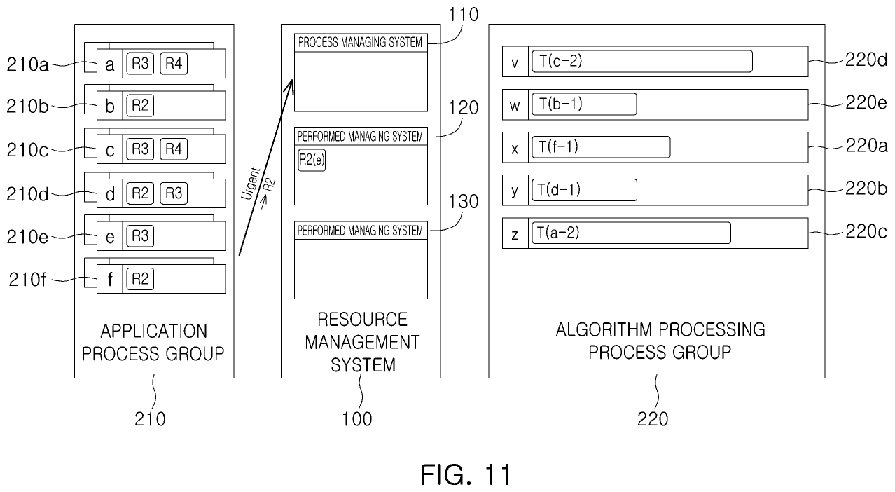

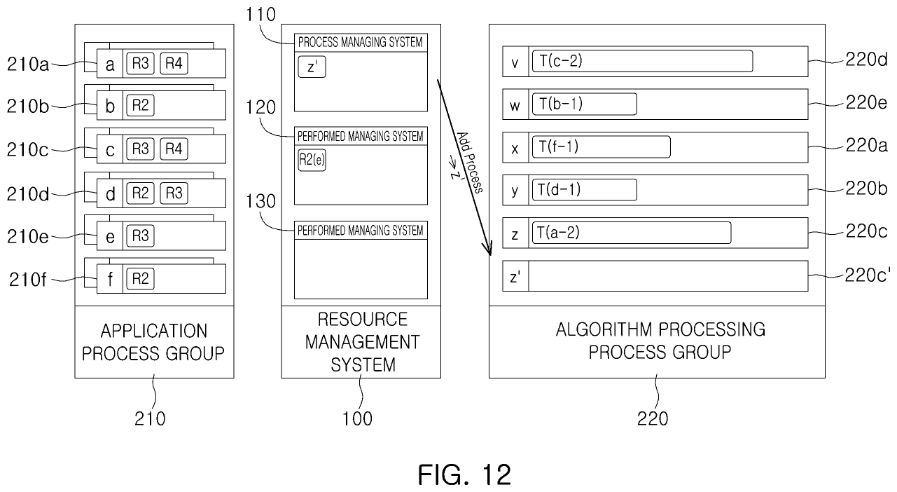

According to FIGS. 11 to 13, when the task managing system 110 receives an urgent task request message R2(e) from the application processes 210, the task managing system 110 transmits the same message to the process managing system 120, and in this case, when the process managing system 120 confirms that all of the algorithm processing processes 220 are busy, the process managing system 120 may request at least one of the computing devices 200 connected in the cluster computing environment to create an additional algorithm processing process z′ (220c′). In this case, the computing device 200 additionally generating the additional algorithm processing process z′ (220c′) is a device having residual computing resources to create an additional algorithm processing process 200c′ in consideration of the residual computing resources of computing devices 200 connected to the cluster computing environment.

When the additional algorithm processing process 200c′ is generated, the process managing system 120 may assign the R2(e) requested for an urgent task to the additional algorithm processing process 200c′.

Furthermore, according to an example embodiment, when there is an algorithm processing process 220 in an idle state to which the application process 210 requested for a task will be assigned after creating the additional algorithm processing process 200c′, the process managing system 120 may request the additional algorithm processing process 200c′ to be removed from at least one computing device 200.

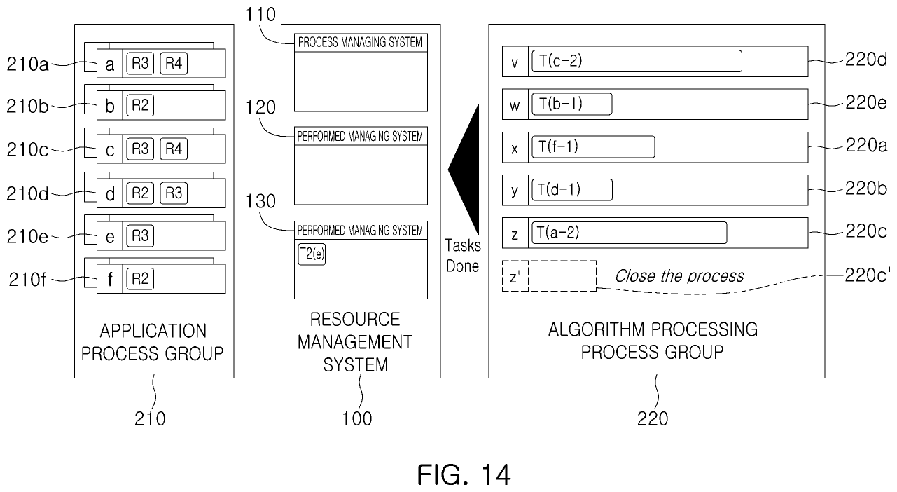

Referring to FIG. 14, the R2(e) requested for an urgent task in the algorithm processing process 200c′ may be performed, and a task performed message T2(e) may be registered in the performed managing system 130. In this case, the algorithm processing process 200c′ may be removed when there is no additional urgent message requested for a task or when there are circumstances in which the residual computing resources are insufficient.

According to an example embodiment, one computing device 200 usually has one algorithm processing process 220, but may be set differently to have an additional algorithm processing process 200c′ from the beginning in consideration of the operation type, algorithm processing costs, and computing power of the computing device 200.

According to an example embodiment, the task managing system 110 may broadcast an application process 210 that requires a task, or may deliver the application process 210 to a computing device 200 including an algorithm processing process 220 to process an algorithm for the application process 210.

Furthermore, according to an example embodiment, the performed managing system 130 may broadcast a result of the application process 210 whose task is performed, or transmit the result to the computing device 200 including the application process 210.

Broadcasting the result of the application process 210 that requires a task or the application process 210 whose task is performed may include that a task request message of the application process 210 that requires a task or a task performed message of the application process 210 whose task is performed is notified to a computing device 200 so that the corresponding computing device 200 may be made to take the message, or that a direct message is transmitted so that a computing device 200 may directly take a task request message of the application process 210 that requires a task or a task performed message of the application process 210 whose task is performed.

Furthermore, the transmission to the computing device 200 including the algorithm processing process 220 or to the computing device 200 including the application process 210 may include providing a task request or a task performed result to a direct corresponding computing device 200.

This may satisfy the efficiency and concurrency of processing high-cost algorithms performed by a plurality of computing devices 200, and can treat high-cost algorithms even in a case in which computing resources from the plurality of computing devices 200 are efficiently used by a plurality of application processes 210, or even in an embedded system other than devices having weak computing resources or PC-type software. In this case, the high-cost algorithm treatment may include a deep learning algorithm.

In addition to the aforementioned example embodiments, algorithm processing may be performed by efficiently selecting the algorithm processing process 220 with various factors such as algorithm characteristics, expected processing time, and a processing completion deadline, and tasks may be divided into a plurality of threads existing within a single process, or a simple change in which some application processes 210 have separate threads for algorithm processing therein may also be made.

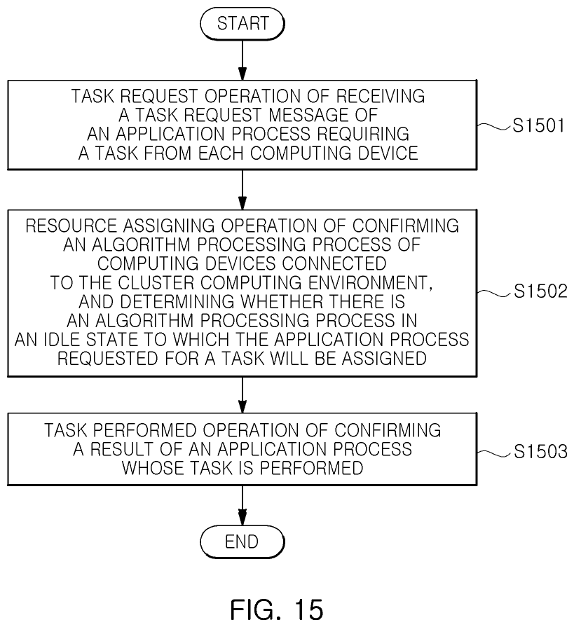

FIG. 15 illustrates a flowchart of a computing resource management method through software modularization according to an example embodiment of the present disclosure.

The computing resource management method through software modularization according to an example embodiment of the present disclosure may be performed in a cluster computing environment in which computing devices 200 are connected, including an application process 210 running on each computing device 200 and an algorithm processing process 220 running independently of the application process (210) and performing task processing for the application process 210.

As illustrated in FIG. 15, the computing resource management method may include a task request operation 51501 of receiving a task request message of an application process 210 that require a task from each computing device 200, a resource assigning operation 51502 of confirming an algorithm processing process 220 of computing devices 200 connected to the cluster computing environment, and determining whether there is an algorithm processing process 200 in an idle state to which the application process 210 requested for a task will be assigned, and a task performed operation 51503 of confirming a result of an application process 2210 whose task is performed.

In the resource assigning operation 51502 according to an example embodiment of the present disclosure, the application process 210 requested for a task may be assigned to the algorithm processing process 220 in an idle state responding to the task request message loaded in the task managing system 110 on a first-come-first-served basis.

As another example embodiment, the application process 210 may be assigned to the algorithm processing process 220 accordingly by applying priority rather than responding on a first-come-first-served basis.

In the task request operation 51501, a task request of the application process 210f (see FIG. 2) that requires a task may be received from a computing device including only the application process 210f (see FIG. 2) running on the computing device, in addition to the computing device 200 connected in the cluster computing environment.

Computing equipment lacking computing power outside the cluster computing environment may also use the algorithm processing process 220 of the computing device 200 connected to the cluster computing environment.

In the resource assigning operation 51502, when there is no algorithm processing process 220 in an idle state to which the application process 210 requested for an urgent task will be assigned, at least one computing device 200 connected in the cluster computing environment may be requested to create an additional algorithm processing process 220c′ (see FIG. 12) in consideration of the remaining computing resources of the computing device 200 connected in the cluster computing environment.

Furthermore, when there is an algorithm processing process 220 in an idle state to which the application process 210 requested for a task will be assigned after creating the additional algorithm processing process 220c′ (see FIG. 12), an additional algorithm processing process 220c′ (see FIG. 12) may be requested to be removed from the at least one computing device 200.

In this case, according to an example embodiment, the task request operation 51501 may include broadcasting an application process 210 that requires a task, or transmitting the application process 210 to the computing device 200 including an algorithm processing process 220 to process the application process 210.

Furthermore, according to an example embodiment, the task performed operation 51503 may include broadcasting a result of an application process 210 whose task is performed, or transmitting the result to the computing device 200 including the application process 210.

The computing device 200 including the application process 210 requested for a task in the task request operation 51501 according to an example embodiment of the present disclosure may differ from the computing device 200 including the algorithm processing process 220 to which the application process 210 requested for a task will be assigned in the resource assigning operation 51502. Task processing efficiency may be improved using the algorithm processing processes 220 belonging to the same computing device 200 as well as algorithm processing processes 220 belonging to other computing devices 200.

In this case, before the task request operation 51501, the computing resource management method may include an operation of separating an algorithm processing process 220 from an application process 210 so that the application process 210 running on each computing device 200 and the algorithm processing process 220 performing task processing on the application process 210 are operated independently, and an operation of integrating and managing the algorithm processing process 220 of each computing device 200 connected in the cluster computing environment in a single process pool. The application process 210 may use an algorithm processing process 220 of another computing device by separating the application process 210 and the algorithm processing process 220 independently. In order to avoid repeating the contents overlapping the above-described contents, further description will be omitted.

A computer program that allows the computing resource management method using software modularization described above to be performed on a computer may be stored in a computer-readable storage medium.

In addition, in describing the present disclosure, ‘unit’ or ‘module’ may be implemented in various ways, such as a processor, program commands executed by the processor, a software module, a micro code, a computer program product, a logic circuit, an application-only integrated circuit, a firmware, etc.

The content of the method disclosed in example embodiments of the present application may be directly implemented by a hardware processor, or may be implemented and performed by a combination of hardware and software modules among the processors. Software modules may be stored in a random access memory, a flash memory, a read-only memory, a programmable read-only memory or an electrically erasable programmable memory, and a conventional storage medium such as a register and the like. The storage medium is disposed in memory, and the processor reads information stored in the memory and combines the information with the hardware to complete the contents of the method described above. To prevent duplication, detailed descriptions are omitted here.

In the implementation process, each of the above-described methods may be performed by a logical integrated circuit of the hardware among the processors or an instruction in the form of software. The content of the method disclosed in example embodiments of the present application may be directly implemented by a hardware processor, or may be implemented and performed by a combination of hardware and software modules among the processors. Software modules may be stored in a random access memory, a flash memory, a read-only memory, a programmable read-only memory or an electrically erasable programmable memory, and a conventional storage medium such as a register and the like. The storage medium is disposed in memory, and the processor reads information stored in the memory and combines the information with the hardware to complete the contents of the method described above.

In other words, those skilled in the art may realize the present disclosure by means of electronic hardware or a combination of computer software and the electronic hardware by combining each exemplary unit and algorithm operations described in the embodiment disclosed herein. Whether these functions are performed in hardware or software depends on the specific applications and design constraints of the technical plan. Those skilled in the art may realize the aforementioned functions using different methods for each specific application, but this realization should not be considered outside the scope of the present application.

In some embodiments provided in the present application, what should be understood is that the disclosed devices and methods may be realized through other methods. For example, the device embodiment described above is only an example, for example, the unit is only a kind of logical functional classification, and there may be other classification methods when actually realized, for example, a plurality of units or assemblies may be combined or integrated into another system, or some features may be ignored or not performed. On the other hand, the coupling or direct coupling or communication connection between each other displayed or discussed may be an indirect coupling or communication connection through some interfaces, devices, or units, and may be electrical, mechanical, or other forms.

The unit described as a separate component above may be physically separate, and components shown as units may or may not be physical units, that is, they may be disposed in one place or distributed among a plurality of network units. Some or all of the units may be selected according to actual demand to realize the purpose of the method of the present embodiment.

That is, each functional unit in each embodiment of the present application may be integrated into a single processing unit, each unit may exist alone, and two or more units may be integrated into a single unit.

When the function is implemented in the form of a software function unit and sold or used as an independent product, it may be stored in one computer-readable storage medium. Based on this understanding, a part of the technical plan of this application that has contributed essentially or to a prior art or a part of the technical plan may be implemented in the form of a software product, a computer software product is stored in one storage medium, and some instructions may be provided, thereby allowing one computer device (which may be a personal computer, server, or network device) to perform all or part of the operations of the method described in each embodiment of this application. The aforementioned storage medium includes a USB memory, a mobile hard disk, a read-only memory (ROM), a random access memory (RAM), and various media that can store a program code such as magnetic disk or CD-ROM.

The present disclosure is not limited to the embodiment described above and the accompanying drawings. The scope of rights of the present invention is intended to be limited by the appended claims. It will be obvious to those skilled in the art that various substitutions, modification and changes in form and details may be made therein without departing from the spirit and scope of the present invention as defined by the appended claims.

What is claimed is:

1. A computing resource management system using software modularization in a cluster computing environment in which computing devices are connected, including an application process running on each computing device and an algorithm processing process configured to run independently of the application process and perform task processing on the application process, the computing resource management system comprising:
a task managing system configured to receive a task request message from an application process requiring a task from each computing device;
a process managing system configured to confirm an algorithm processing process of computing devices connected to the cluster computing environment, and determine whether there is an algorithm processing process in an idle state to which the application process requested for a task will be assigned; and
a performed managing system configured to confirm a result of an application process whose task is performed by the algorithm processing process.

2. The computing resource management system using software modularization according to claim 1, wherein the task managing system, the process managing system, and the performed managing system are performed in at least one computing device connected in the cluster computing environment.

3. The computing resource management system using software modularization according to claim 1, wherein the task managing system is configured to,
receive a task request of an application process requiring a task from a computing device including only an application process running on computing devices in addition to the computing devices connected in the cluster computing environment.

4. The computing resource management system using software modularization according to claim 1, wherein a computing device including the application process requested for a task is different from a computing device including the algorithm processing process to which the application process requested for a task will be assigned.

5. The computing resource management system using software modularization according to claim 1, wherein, when there is no algorithm processing process in an idle state to which an application process requested for an urgent task will be assigned, the process managing system is configured to,
in consideration of residual computing resources of the computing devices connected in the cluster computing environment, request at least one computing device connected to the cluster computing environment to create an additional algorithm processing process.

6. The computing resource management system using software modularization according to claim 5, wherein the process managing system is configured to,
when there is an algorithm processing process in an idle state to which the application process requested for a task will be assigned after creating the additional algorithm processing process, request the additional algorithm processing process to be removed from the at least one computing device.

7. The computing resource management system using software modularization according to claim 1, wherein the task managing system is configured to,
broadcast an application process requiring a task, or transmit the application process to a computing device including an algorithm processing process to process algorithm for the application process.

8. The computing resource management system using software modularization according to claim 1, wherein the performed managing system is configured to,
broadcast a result of an application process whose task is performed, or transmit the result to a computing device including the application process.

9. The computing resource management system using software modularization according to claim 1, wherein the process managing system is configured to,
integrate and manage the algorithm processing process of the computing devices connected to the cluster computing environment, and
assign the application process requested for a task to an algorithm processing process in an idle state.

10. The computing resource management system using software modularization according to claim 1, further comprising:
a database configured to store data required for performing algorithmic processing of the application process, wherein the data includes metadata or parameter data; and
a remote logic storage configured to store low-level (RAW) data.

11. A computing resource management method using software modularization in a cluster computing environment in which computing devices are connected, including an application process running on each computing device and an algorithm processing process configured to run independently of the application process and perform task processing on the application process, the computing resource management method comprising:
a task request operation of receiving a task request message of an application process requiring a task from each computing device;
a resource assigning operation of confirming an algorithm processing process of computing devices connected to the cluster computing environment, and determining whether there is an algorithm processing process in an idle state to which the application process requested for a task will be assigned; and
a task performed operation of confirming a result of an application process whose task is performed.

12. The computing resource management method using software modularization according to claim 11, wherein the resource assigning operation comprises:
assigning the application process requested for a task to an algorithm processing process in an idle state responding to a task request message loaded in a task managing system on a first-come-first-served basis.

13. The computing resource management method using software modularization according to claim 11, wherein the task request operation comprises:
receiving a task request of an application process requiring a task from a computing device including only an application process running on the computing device in addition to the computing devices connected to the cluster computing environment.

14. The computing resource management method using software modularization according to claim 11, wherein the resource assigning operation comprises:
when there is no algorithm processing process in an idle state to which the application process requested for an urgent task will be assigned,
in consideration of residual computing resources of the computing devices connected in the cluster computing environment, requesting at least one computing device connected to the cluster computing environment to create an additional algorithm processing process.

15. The computing resource management method using software modularization according to claim 14, wherein the resource assigning operation comprises:
when there is an algorithm processing process in an idle state to which the application process request for a task will be assigned after creating the additional algorithm processing process, requesting the additional algorithm processing process to be removed from the at least one computing device.

16. The computing resource management method using software modularization according to claim 11, wherein the task request operation comprises:
broadcasting an application process requiring a task, or transmitting the application process to a computing device including an algorithm processing process to process the algorithm for the application process.

17. The computing resource management method using software modularization according to claim 11, wherein the task performed operation comprises:
broadcasting a result of an application process whose task is performed, or transmitting the result to the computing device including the application process.

18. The computing resource management method using software modularization according to claim 11, wherein a computing device including the application process requested for a task in the task request operation is different from a computing device including the algorithm processing process to which the application process requested for a task will be assigned in the resource assigning operation.

19. The computing resource management method using software modularization according to claim 11, comprising:
prior to the task request operation,
in order to operate an application process running on each computing device independently of an algorithm processing process performing task processing on the application process, separating the algorithm processing process from the application process; and
integrating and managing the algorithm processing process of each computing device connected to the cluster computing environment in a single process pool.

20. A computer-readable storage medium having a computer program stored therein that allows the computing resource management method using software modularization according to claim 11 to be performed on a computer.
